(19) United States
(12) Patent Application Publication
(10) Pub. No.: US 2024/0250755 A1
(43) Pub. Date: Jul. 25, 2024

(54) Coherent Optical Receiver

(71) Applicant: Nippon Telegraph and Telephone Corporation, Tokyo (JP)

(72) Inventors: Mitsumasa Nakajima, Musashino-shi, Tokyo (JP); Toshikazu Hashimoto, Musashino-shi, Tokyo (JP)

(21) Appl. No.: 18/560,764

(22) PCT Filed: Jun. 11, 2021
(86) PCT No.: PCT/JP2021/022308

§ 371 Date: Nov. 14, 2023

(51) Int. Cl. H04B 10/61

(52) U.S. Cl. CPC H04B 10/615; H04B 10/6165

(57) ABSTRACT

The present disclosure provides a coherent optical receiver that reproduces an optical complex signal that was used when an optical signal was generated in a coherent optical transmitter, without any use of local carrier light. The coherent optical receiver includes: an optical convolution circuit that performs optical signal processing on an optical signal received via an optical transmission line; a photodetector that converts the optical signal subjected to the optical signal processing into an electrical signal having the intensity waveform of the optical signal subjected to the optical signal processing; and a demodulation algorithm that estimates a complex time-series signal by performing digital signal processing on the electrical signal, and sets the estimated complex time-series signal as a result of reproduction of the complex time-series signal used in generating the optical signal.

### TECHNICAL FIELD

The present disclosure relates to coherent communication, and more specifically, to a coherent optical receiver that reproduces an optical complex signal without any use of local carrier light.

### BACKGROUND ART

With the explosive increase in communication traffic accompanying the spread of smartphones and the Internet, the capacity of optical communication is being made even larger. To meet such a demand in optical communication, attention is being drawn to a coherent transmission/reception technology based on a wavelength/polarization/spatial multiplexing technology using parallelism light or a multilevel modulation technology using a complex space.

FIG. 1(a) is a schematic diagram of a general wavelength division multiplexing (WDM) coherent communications system. In the general WDM coherent communication system, optical signals of a plurality of wavelengths modulated by in-phase/quadrature (I/Q) modulators forming coherent optical transmitters (TX) 101-1 to 101-N are multiplexed (wavelength-multiplexed) by an optical multiplexer (MUX) circuit 102 (an arrayed waveguide grating (AWG) or the like, for example), and are sent to the reception side via an optical transmission line 103. The integer N is the number of wavelengths to be subjected to wavelength multiplexing. On the reception side, each wavelength signal is demultiplexed (wavelength-separated) by an optical demultiplexer (DEMUX) circuit 104 (an AWG or the like, for example), and a plurality of optical signals demultiplexed for each wavelength is demodulated by coherent optical receivers 105-1 to 105-N. The signals demodulated by the coherent optical receivers 105-1 to 105-N are processed by digital signal processing (DSP) devices 106-1 to 106-N.

FIG. 1(b) is a configuration diagram of a general coherent optical receiver (RX) 105. In the coherent optical receivers (RX) 105-1 to 105-N, to reproduce optical signals 107-1 to 107-N modulated in a complex space by causing coherence between them, highly accurate optical coherence systems 109-1 to 109-N called 90-degree hybrids, laser light sources 108-1 to 108-N that generate highly stable local carrier light of narrow linewidth, and balanced photodetectors (PDs) 110-1 to 110-N are necessary. Typically, the balanced photodetector 110 connected to one optical coherence system 109 includes a set of PDs. Because of this, the device configuration of the coherent optical receiver 105 becomes more complicated than that in the case of direct detection using intensity modulation. Also, the digital signal processing devices 106-1 to 106-N corresponding to the coherent optical receivers 105-1 to 105-N, respectively, are required for distortion compensation and determination of the respective signals.

As an optical restoration method not using local carrier light, there is a known method by which optical signals are scattered with a multimode fiber or the like (see Non Patent Literature 1, for example). With the use of a two-dimensional PD array, signals scattered in a temporal/spatial direction are oversampled, and thus, signal restoration is performed.

### CITATION LIST

### Non Patent Literature

Non Patent Literature 1: Y. Yoshida et al., “Coherent Detection only by 2-D Photodetector Array: A Discreteness-aware Phase Retrieval Approach”, 2019 Optical Fiber Communications Conference and Exhibition (OFC), page Th4A.3, OFC, 2019

### SUMMARY OF INVENTION

### Technical Problem

By the conventional optical restoration method that does not use local carrier light, however, the scatter coefficient is treated as a known value, and therefore, it is necessary to measure the scatter coefficient separately, and set a plurality of hyperparameters. Furthermore, in a configuration using a multimode fiber, the scatter coefficient is not stabilized over time due to deflection or vibration of the optical fiber, and it is necessary to measure the scatter coefficient many times.

The present disclosure is made in view of such problems, and aims to provide a coherent optical receiver that reproduces the optical complex signal that was used when an optical signal was generated in a coherent optical transmitter, without any use of local carrier light.

### Solution to Problem

To achieve such an objective, an embodiment of the present invention is a coherent optical receiver that reproduces the complex time-series signal that was used in generating an optical signal received via an optical transmission line, and includes: an optical convolution circuit that performs optical signal processing on the received optical signal; a photodetector that converts the optical signal subjected to the optical signal processing into an electrical signal having the intensity waveform of the optical signal subjected to the optical signal processing; and a demodulation algorithm that estimates a complex time-series signal by performing digital signal processing on the electrical signal, and sets the estimated complex time-series signal as a result of reproduction of the complex time-series signal used in generating the optical signal.

With the coherent optical receiver of an embodiment of the present invention, it is possible to reproduce the optical complex signal used when an optical signal was generated in an optical transmitter, by performing an optical operation on the optical signal in an optical circuit and a digital operation based on the intensity of the optical signal subjected to the optical operation.

According to the present disclosure, it is possible to scatter optical signals using a highly stable optical waveguide. Thus, any updating is unnecessary once the scatter coefficient (corresponding to the impulse response h in the following description) is determined, which is an excellent advantage. Furthermore, with a digital operation algorithm according to the present disclosure, it is possible to determine the scatter coefficient without prior knowledge.

### BRIEF DESCRIPTION OF DRAWINGS

FIG. 1(a) is a schematic diagram of a general WDM coherent communication system, and FIG. 1(b) is a configuration diagram of a general coherent optical receiver (RX) 105.

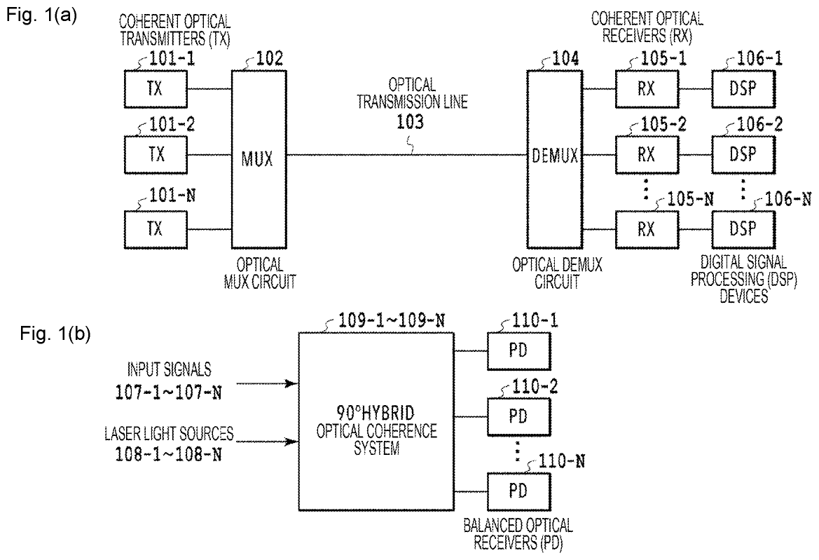

FIG. 2 is a schematic diagram of a WDM coherent communication system including a coherent optical receiver according to an embodiment of the present invention.

FIGS. 3(a), 3(b), and 3(c) are configuration diagrams of optical circuits that can be used as optical convolution circuits included in a coherent optical receiver according to an embodiment of the present invention.

FIGS. 4(a) and 4(b) are configuration diagrams of optical circuits that can be used as optical convolution circuits included in a coherent optical receiver according to an embodiment of the present invention.

FIG. 5 is a configuration diagram of a demodulation algorithm included in a coherent optical receiver according to an embodiment of the present invention.

FIG. 6 is a configuration diagram of an optical circuit that can be used as optical convolution circuit included in a coherent optical receiver according to an embodiment of the present invention.

FIGS. 7(a) and 7(b) are graphs for explaining estimation results in a case where the Wirtinger flow was used for a demodulation algorithm.

FIG. 8 is a graph for explaining a result of estimation in a case where a demodulation algorithm included in a coherent optical receiver according to an embodiment of the present invention was used.

### DESCRIPTION OF EMBODIMENTS

The following is a description of embodiments of the present invention, with reference to the drawings. The same or similar reference numerals in the drawings denote the same or similar components, and repetitive explanation of them will not be made in some cases. In the description below, a coherent optical transmitter will be sometimes referred to as TX, and a coherent optical receiver will be sometimes referred to as RX.

### First Embodiment

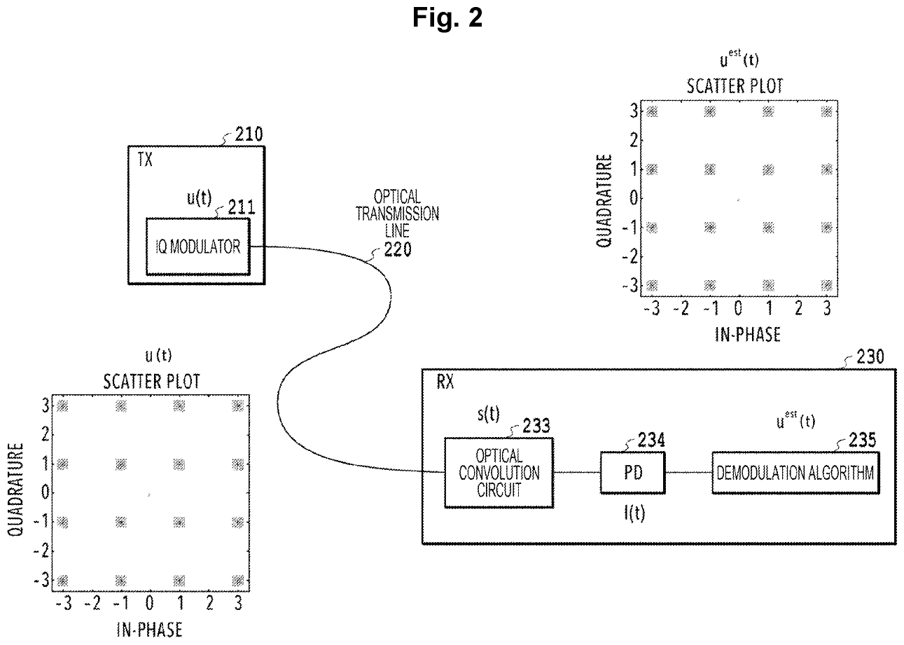

Referring now to FIG. 2, a coherent optical receiver according to a first embodiment is described. FIG. 2 is a schematic diagram of a WDM coherent communication system including a coherent optical receiver according to this embodiment. This embodiment provides a method for estimating a complex signal of a single coherent optical transmitter (TX) 210 from an intensity waveform of a single PD 234 of a coherent optical receiver (RX) 230. An I/Q modulator 211 of the TX 210 on the transmission side modulates light of a predetermined wavelength on the basis of the complex time-series signal u(t), to generate optical signals. Modulated optical signals of a plurality of wavelengths from a plurality of TXs 210 are wavelength-multiplexed by an optical MUX (not illustrated), and are transmitted to RXs 230 on the reception side via optical transmission lines 220. An RX 230 receives an optical signal of a specific wavelength subjected to wavelength demultiplexing by an optical DEMUX (not illustrated). Optical signals to be transmitted and received between the TXs 210 and the RXs 230 via the optical transmission lines 220 may or may not be wavelength-multiplexed. The coherent optical receiver of this embodiment may be used in a coherent optical communication system that does not include any optical MUX and any optical DEMUX.

A RX 230 includes an optical convolution circuit 233 that performs optical signal processing on an optical signal of a specific wavelength subjected to wavelength demultiplexing, a photodetector (PD) 234 that detects an optical signal from the optical convolution circuit 233, and a demodulation algorithm 235 that performs digital signal processing on an electrical signal converted from the optical signal by the PD 234. The demodulation algorithm 235 performs the computation described later.

In the RX 230, a complex time-series signal u(t) introduced into received optical signal is subjected to conversion corresponding to Expression (1) via the optical convolution circuit 233.

$$\begin{matrix}[ Math . 1 ] & \\ s ( t ) = {\sum }_{i} {h}_{i} u ( t - i θ ) ≡ h * u ( t ) & ( 1 )\end{matrix}$$

Here, h represents the impulse response of the optical convolution circuit 233. θ represents the delay time difference given by a delay line of the optical convolution circuit 233, and is equal to or shorter than the sampling time of the PD 234. Further, i represents the number allocated to a branching unit of the optical convolution circuit 233. Here, * is the symbol for a convolution operation. Expression (1) is equivalent to a convolution operation of an input signal u in a one-dimensional kernel filter with the impulse response h.

The optical convolution circuit 233 includes, as a component, an optical waveguide formed with a material that transmits light, such as quartz glass or silicon. The optical convolution circuit 233 includes at least one optical branching unit, an optical delay line connected to an output of the optical branching unit, at least one optical merging unit connected to the optical delay line, and a phase shifter disposed in a portion or the entire portion of the optical delay line. The optical convolution circuit 233 may include a variable attenuator disposed on a portion or the entire portion of the optical delay line. The optical delay line gives a delay difference corresponding to a sampling time θ, to the optical signal branched by the branching unit. The impulse response h is determined by the branching ratio at each branching unit that is a component of the optical convolution circuit 233, the length of the optical delay line, the phase given to the optical signal by the phase shifter, or the attenuation given by the variable attenuator. By disposing a Mach-Zehnder interferometer (MZI) or the like at each branching unit, the delay line, and the merging unit, it is also possible to adjust the branching ratio and the phase, and make the impulse response h variable. The impulse response h may be a random number sequence. The impulse response h that is a random number sequence can be obtained by designing or setting the phase difference at each arm of the MZI forming the optical convolution circuit 233 (which is the phase difference given by a phase shifter 303 disposed on an optical delay line 302), the attenuation in a variable attenuator 304, and the branching ratio at a branching unit 301, in accordance with random numbers.

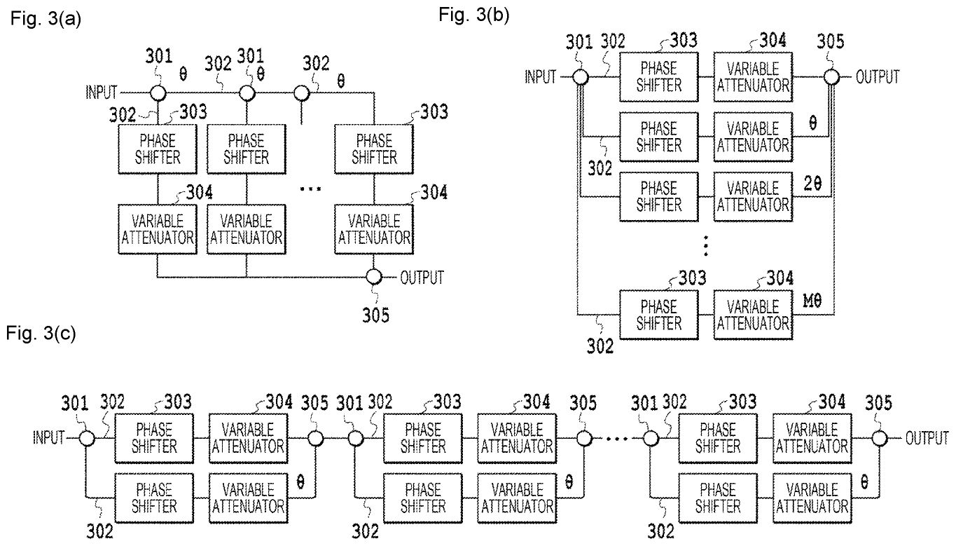

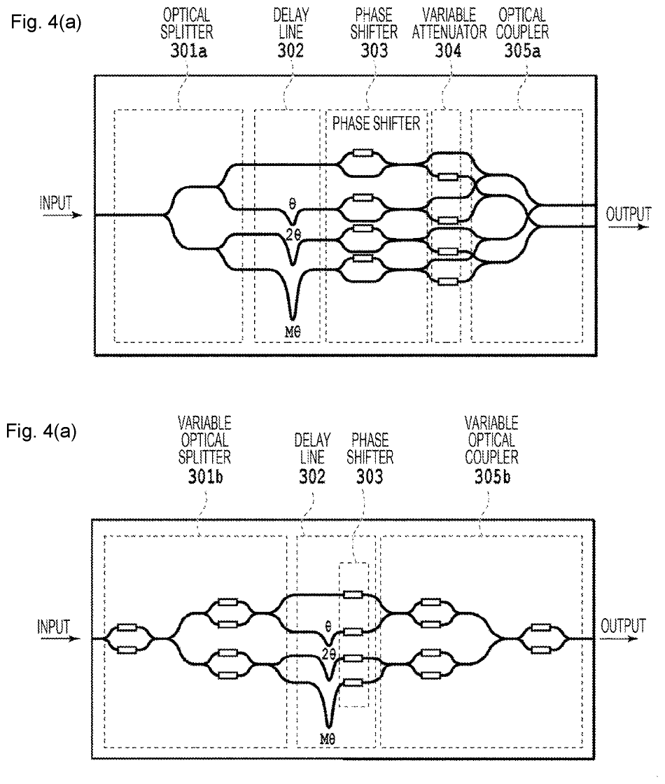

Referring to FIGS. 3 and 4, a more specific and preferable configuration of the optical convolution circuit 233 is described.

FIG. 3(a) is a functional configuration of an optical circuit that can be used as the optical convolution circuit 233, and is an optical circuit that functions as a finite impulse response (FIR) filter. The optical circuit illustrated in FIG. 3(a) has a configuration in which branching units that branch light into two light beams are connected in M stages. A phase shifter 303 and a variable attenuator 304 are disposed on an optical delay line 302 connected to one of the two outputs of a branching unit 301. The other delay line on which the phase shifter 303 and the variable attenuator 304 are not disposed is connected to the next branching unit 301. In the branching unit 301 of the Mth stage, the phase shifter 303 and the variable attenuator 304 are disposed on both of the two outputs. The two optical delay lines 302 are designed so that the delay difference to be given between the light beams being guided in these lines becomes θ. The light beams branched by the M branching units 301 are given a total delay difference of Me, and are output from a merging unit 305. Of the optical delay differences sequentially output from the merging unit 305, the delay difference between the light output first and the light output second has the smallest value (θ), and the delay difference between the light output first and the light output last has the largest value (Mθ). The light beams branched by the M branching units 301 are sequentially output from the merging unit 305 without overlapping one another.

FIG. 3(b) is an example of an optical circuit having a functional configuration equivalent to a FIR filter, and is an optical circuit that functions as a transversal filter. In the optical circuit illustrated in FIG. 3(b), phase shifters 303 and variable attenuators 304 are disposed on all M optical delay lines 302 connected to M outputs of a branching unit 301 that branches light into M light beams. Two adjacent optical delay lines 302 are designed so that the delay difference to be given between the light beams being guided in these lines becomes θ. The delay difference to be given between light beams guided in the two optical delay lines 302 that are the most distant from each other is Mθ. The light beams that have propagated through the M optical delay lines 302 are output from a merging unit 305. Of the optical delay differences sequentially output from the merging unit 305, the delay difference between the light output first and the light output second has the smallest value (θ), and the delay difference between the light output first and the light output last has the largest value (Mθ). The M light beams branched by the branching unit 301 are sequentially output from the merging unit 305 without overlapping one another.

FIG. 3(c) is an optical circuit that can be used as the optical convolution circuit 233, and is an optical circuit that functions as an M-stage lattice filter. In the optical circuit illustrated in FIG. 3(c), phase shifters 303 and variable attenuators 304 are disposed on both of the two optical delay lines 302 connected to the two outputs of a branching unit 301 that branches light into two light beams. The two optical delay lines 302 are designed so that the delay difference to be given between the light beams being guided becomes θ. The light beams that have propagated through the two optical delay lines 302 are sequentially output from a merging unit 305, and are input to the branching unit 301 of the next stage. The smallest delay difference between light beams output from the merging units 305 of the Mth stage is θ, and the largest delay difference is Mθ. Of the optical delay differences sequentially output from the merging unit 305 of the Mth stage, the delay difference between the light output first and the light output second has the smallest value (θ), and the delay difference between the light output first and the light output last has the largest value (Mθ). The light beams split by the M branching units 301 are sequentially output from the merging unit 305 of the Mth stage without overlapping one another.

An optical circuit that can be used as the optical convolution circuit 233 can also be implemented with the use of an MZI and a delay line.

FIG. 4(a) illustrates an example (a case where M=4) of implementation of an optical circuit that has the functions of a transversal filter. The optical circuit is a planar lightwave circuit (PLC), and each component includes optical waveguides formed on a substrate. As illustrated in FIG. 4(a), in the optical circuit, a branching unit 301 that branches input light into four light beams is formed with an optical splitter 301a, and a merging unit 305 is formed with an optical coupler 305a. The optical splitter 301a, the optical coupler 305a, and four optical waveguides between the outputs of the optical splitter 301a and the inputs of the optical coupler 305a constitute an MZI, and the arm waveguides of the MZI form optical delay lines 302. Phase shifters 303 and variable attenuators 304 are disposed on the optical delay lines 302. The four optical delay lines 302 give different delays (0, θ, 2θ, and Mθ) to the respective light beams being guided. Accordingly, the delay differences between the light beam propagating in the uppermost arm waveguide and the light beams propagating in the second to Mth arm waveguides from the top are different from one another. The four light beams split by the optical splitter 301a forming the branching unit 301 are sequentially output from the optical coupler 305a forming the merging unit 305, without overlapping one another. In the optical coupler 305a illustrated in FIG. 4(a), the light to which a phase has been given by the phase shifters 303 and been attenuated by the variable attenuators 304 is emitted from the lower output.

Further, when an attenuator is used in an optical circuit, some optical power is lost, leading to degradation of the signal-to-noise ratio (S/N ratio). In view of this, the branching units 301 of the optical circuits illustrated in FIGS. 3(a), 3(b), and 3(c) may be formed with variable optical splitters, and the variable attenuators 304 may be excluded. With this arrangement, an optical signal convolution operation can be advantageously performed without any principle loss.

FIG. 4(b) is an optical circuit that can be used as the optical convolution circuit 233, and is a modification of the optical circuit having the functions of a transversal filter illustrated in FIG. 4(a). In the optical circuit illustrated in FIG. 4(b), the optical splitter 301a forming the branching unit 301 that splits input light into four light beams in FIG. 4(a) is replaced with a variable optical splitter 301b, to make the branching ratio variable. Also, in the optical circuit illustrated in FIG. 4(b), the optical coupler 305a forming the merging unit 305 in FIG. 4(a) is replaced with a variable optical coupler 305b, to make the merging ratio variable. The variable optical splitter 301b, the variable optical coupler 305b, and four optical waveguides between the outputs of the variable optical splitter 301b and the inputs of the variable optical coupler 305b constitute an MZI, and the arm waveguides of the MZI form optical delay lines 302. Phase shifters 303 are disposed on the optical delay lines 302. In the optical circuit illustrated in FIG. 4(b), the variable attenuators 304 in FIG. 4(a) are excluded. The four optical delay lines 302 give different delays (0, θ, 2θ, and Mθ) to the respective light beams being guided. Accordingly, the delay differences between the light beam propagating in the uppermost arm waveguide and the light beams propagating in the second to Mth arm waveguides from the top are different from one another. The four light beams split by the variable optical splitter 301b forming the branching unit 301 are sequentially output from the variable optical coupler 305b forming the merging unit 305, without overlapping one another.

Referring back to FIG. 2, the optical signal s(t) converted by the optical convolution circuit 233 is subjected to square-law detection performed by the PD 234. Accordingly, the optical signal s(t) is converted as shown in Expression (3), and turns into an intensity signal I(t). Through the square-law detection, the intensity signal I(t) has lost intensity information.

$$\begin{matrix}[ Math . 2 ] & \\ I ( t ) = {\vert s ( t ) \vert}^{2} & ( 2 )\end{matrix}$$

On the basis of I(t) from the optical convolution circuit 233, the demodulation algorithm 235 estimates the complex time-series signal u(t) used when the I/Q modulator 211 on the input side generated the optical signal, to obtain a demodulated complex time-series signal u^{est} (t). By minimizing the cost function L shown in Expression (3) below, it is possible to obtain a likely estimated demodulated complex signal. As the difference between the intensity signal I(t) of the optical signal obtained by optically convolving the optical signal received in the optical convolution circuit 233, which is the result of the measurement by the PD 234, and the intensity signal of the estimated demodulated complex signal becomes smaller, the demodulated complex time-series signal u^{est} (t) is estimated in a more likely manner, which can mean that the complex time-series signal u(t) is successfully restored.

$$\begin{matrix}[ Math . 3 ] & \\ L = {‖ I ( t ) - {\vert h * {u}^{est} ( t ) \vert}^{2} ‖}^{2} & ( 3 )\end{matrix}$$

To minimize L, it is preferable to calculate a gradient in a direction in which L becomes smaller, and use a gradient descent algorithm such as a steepest descent method. However, since L involves an operation for determining the absolute value of the complex number, it is not possible to calculate the differential of Expression (3) to obtain a gradient in a direction in which L becomes smaller. Therefore, a method for minimizing L by calculating the Wirtinger derivative of L (Wirtinger flow) can be considered. By this method, Expression (4) shown below is executed n times, so that u^{est} (t) that is asymptotically likely is obtained.

$$\begin{matrix}[ Math . 4 ] & \\ {u}_{n + 1}^{est} = {u}_{n}^{est} + \frac{λ ( n )}{{\vert {u}_{0}^{est} \vert}^{2}} {h}^{*} * ( I - {\vert {h}_{j} * {u}_{n}^{est} \vert}^{2} ) ( h * {u}_{n}^{est} ) & ( 4 )\end{matrix}$$

Here, the integer n indicates the number of repetitions, h* represents the Hermitian conjugate of h, and λ(n) represents the variable indicating how much update is to be made in the gradient direction in each step. The demodulated complex time-series signal u^{est} is updated on the basis of Expression (4), so that L can be minimized, and the original complex time-series signal u(t) can be restored. Meanwhile, since u^{est} has a higher dimension than I, there is a plurality of possible solutions for L. To solve the above, a pilot tone may be provided, and be substituted into u^{est} obtained in each step. As for the pilot tone, a known signal may be transmitted from a TX 210 to a RX 230, and this signal may be set as the pilot tone. With this arrangement, an excellent effect to obtain u^{est} that is closer to u can be achieved. Further, when the PD 234 measures an intensity signal I, sampling may be performed at a rate (θ/2 or θ/4, for example) that is higher than the symbol rate of the complex time-series signal u used on the input side. With this arrangement, the dimension of the intensity signal I can be made higher than the dimension of the complex time-series signal u. Thus, an excellent effect to obtain a demodulated complex time-series signal u^{est} that is closer to u can be achieved.

In the above algorithm, the Hermitian conjugate h* of the impulse response h of the optical convolution circuit 233 and the variable λ(n) indicating the degree of update in the gradient direction in Expression (4) are used as parameters. Therefore, it is necessary to measure h with high accuracy beforehand to obtain h*, and empirically determine λ(n). Here, Expression (4) is regarded as a unit of a neural network, and the step number n is regarded as the number of layers, so that h and λ(n) can be optimized from learning data.

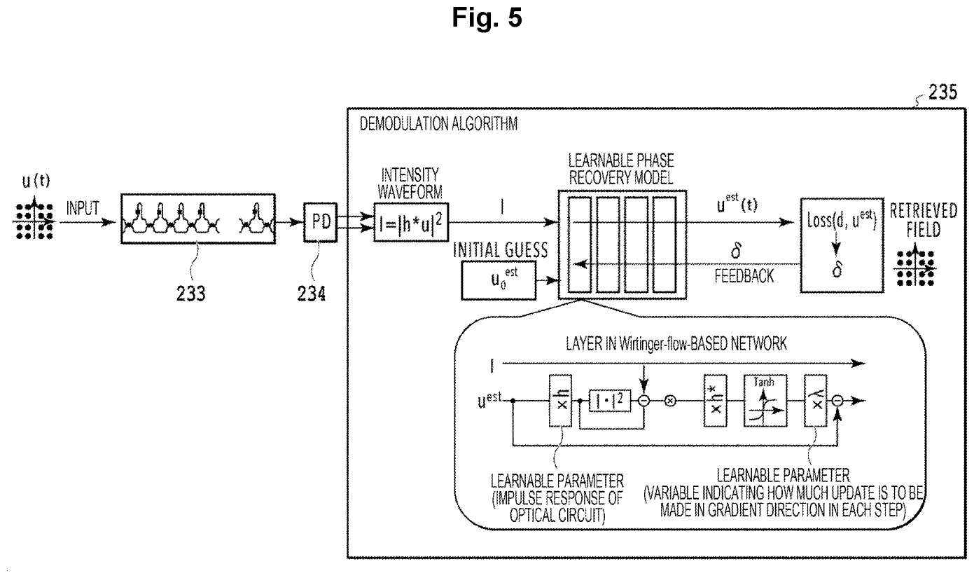

FIG. 5 is a diagram illustrating the configuration of the demodulation algorithm 235. The demodulation algorithm 235 is formed with a computer including a processor and a memory storing a program, for example, and causes the processor to execute the program, to perform an operation of the neural network using Expression (4) as a unit.

The demodulation algorithm 235 is designed to receive an intensity signal I(t) that is a result of square-law detection performed by the PD 234. The intensity signal I(t) is supplied, together with the initial value u₀^{est} of the demodulated complex time-series signal u^{est}, to a learnable phase recovery model. The initial values of h and λ are also supplied, together with the initial value u₀^{est}, to the learnable phase recovery model. Each layer in the learnable phase recovery model is a layer in a Wirtinger-flow-based network, and performs an operation according to Expression (4). In each layer, calculation of Tanh may be skipped. The estimated demodulated complex time-series signal u^{est} that is a result of an operation of the learnable phase recovery model is compared with training data d, and a difference (Loss (d, u^{est})) is calculated. The training data d can be the original complex time-series signal u. Information δ corresponding to the difference (Loss (d, u^{est})) is fed back, and is used as the initial value in the next calculation. The information δ includes updated h or Δ. The smaller the difference (Loss (d, u^{est})), the more sufficiently h can be optimized. The optimized h is used in the subsequent calculation of the demodulated complex time-series signal u^{est}.

As a result, it becomes possible to estimate the original complex time-series signal u by obtaining a likely demodulated complex time-series signal u^{est} without the need for prior knowledge of h and λ(n), which is an excellent feature. Here, to reduce the calculation and the number of pieces of training data, the parameters of each layer of the neural network are common to all layers. Although FIG. 5 illustrates a time domain, an input signal may be subjected to Fourier transform, and be written in a frequency domain.

### Second Embodiment

In the first embodiment, the optical convolution circuit 233 has one input port for inputting one optical signal of a specific wavelength among a plurality of optical signals subjected to wavelength demultiplexing by an optical DEMUX, and one output port for outputting the intensity signal I to be supplied to the PD 234. The optical convolution circuit may have a plurality of input ports and a plurality of output ports.

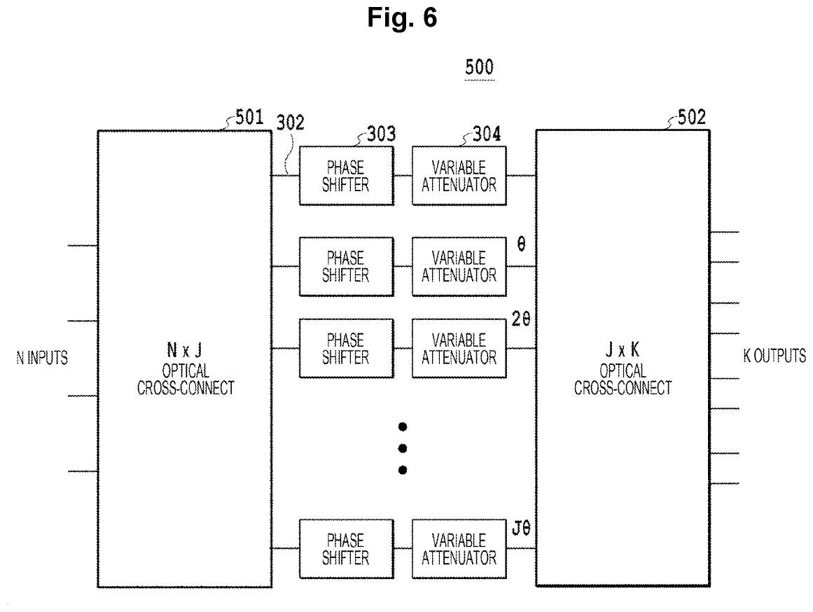

Referring now to FIG. 6, a coherent optical receiver according to a second embodiment is described. FIG. 6 illustrates an example configuration of an N×K optical convolution circuit 500 having N input ports and K output ports, as a modification of the optical convolution circuit 233. The optical convolution circuit of this embodiment includes: an N×J optical cross-connect 501 having N inputs and J outputs; a J×K optical cross-connect 502 having J inputs and K outputs; J optical delay lines 302 connecting the J output ports of the N×J optical cross-connect 501 and the J input ports of the J×K optical cross-connect 502; and phase shifters 303 and variable attenuators 304 disposed on the respective optical delay lines 302. The integer N indicates the number of wavelengths to be subjected to wavelength multiplexing in the WDM coherent communication system. J and K are integers equal to or greater than N.

The J optical delay lines 302 are designed so that a delay difference between adjacent optical delay lines becomes θ. The delay difference to be given between light beams guided in the two optical delay lines 302 that are the most distant from each other is Je.

The N×J optical cross-connect 501 distributes N optical signals that have been input to the N input ports and been subjected to wavelength demultiplexing from WDM signals by an optical DEMUX, to the J output ports.

Each of the optical signals distributed to the J output ports is given a delay differences by the optical delay line 302, is given a phase by the phase shifter 303, is attenuated by the variable attenuator 304, and is input to the J×K optical cross-connect 502.

The J×K optical cross-connect 502 distributes the input optical signals to the K output ports.

The N×K optical convolution circuit 500 functions as a transversal filter.

K PDs 234-1 to 234-K (not illustrated) are connected to the K output ports of the J×K optical cross-connect 502. The demodulation algorithm 235 performs the following operation on the signals supplied from the K PDs 234-1 to 234-K (not illustrated).

The vector s(t) of the optical signal output to each output port of the N×K optical convolution circuit 500 in FIG. 6 is expressed as shown in the following expression.

$$\begin{matrix}[ Math . 5 ] & \\ s ( t ) = h * u ( t ) & ( 5 )\end{matrix}$$

The vector u(t) is the vector of the complex time-series signal introduced into the optical signal input from each input port of the N×K optical convolution circuit 500. The matrix h is the matrix in which the impulse response from each input port to each output port of the N×K optical convolution circuit 500 is stored. To form such a matrix h, the configuration of a transversal filter like the N×K optical convolution circuit 500 in FIG. 6 may be changed, for example. As described above, by making the ratio of distribution from the N input ports to the J output ports variable in the N×J optical cross-connect 501, the variable attenuators 304 can be excluded.

Since the optical signals output from the N×K optical convolution circuit 500 are subjected to square-law detection performed by the PDs 234-1 to 234-K (not illustrated), the optical signals are converted as shown in Expression (6), and turn into intensity signals.

$$\begin{matrix}[ Math . 6 ] & \\ I ( t ) = {\vert s ( t ) \vert}^{2} & ( 6 )\end{matrix}$$

Through the square-law detection, the vector signal I(t) has lost intensity information. On the basis of the vector I(t), the demodulation algorithm 235 estimates the vector u(t) of the complex time-series signal. This can be obtained by replacing I(t), L, and u^{est} in Expression (3) with vectors, and minimizing the cost function L. The same configuration as that of the first embodiment can be used for demodulating this signal. That is, the operation of the demodulation algorithm 235 described above should be extended to the vector and matrix calculation.

### (Examples of Learning)

As an example of learning in the demodulation algorithm 235, a simulation of estimation of 16-QAM signals was conducted. In the simulation, calculation was performed in a baseband, and the influence of band narrowing and group delays by the optical filters in the optical transmission lines 220 were ignored. The baud rate in the I/Q modulator 211 of the coherent optical transmitter 210 was set to 32G bauds. The optical convolution circuit 233 was based on the 32-stage lattice filter configuration illustrated in FIG. 3(c). The branching units 301 were formed with variable optical splitters 301b, the merging units 305 were formed with variable optical couplers 305b, and the variable attenuators 304 were excluded. The optical path length difference (the delay difference θ to be given to an optical signal) between two optical delay lines 302 connecting the variable optical splitters 301b and the variable optical couplers 305b was set to half the length of a bit, and the branching ratio in the variable optical splitters 301b, the merging ratio in the variable optical couplers 305b, and the phase differences to be given by the phase shifters 303 were all generated as random numbers. The PD 234 oversamples the optical signals from the optical convolution circuit 233 at a rate six times higher than the baud rate in the I/Q modulator 211. Here, 20% of the optical signals transmitted from the TX 210 are known to the RX 230, and this known optical signals was used as a pilot tone.

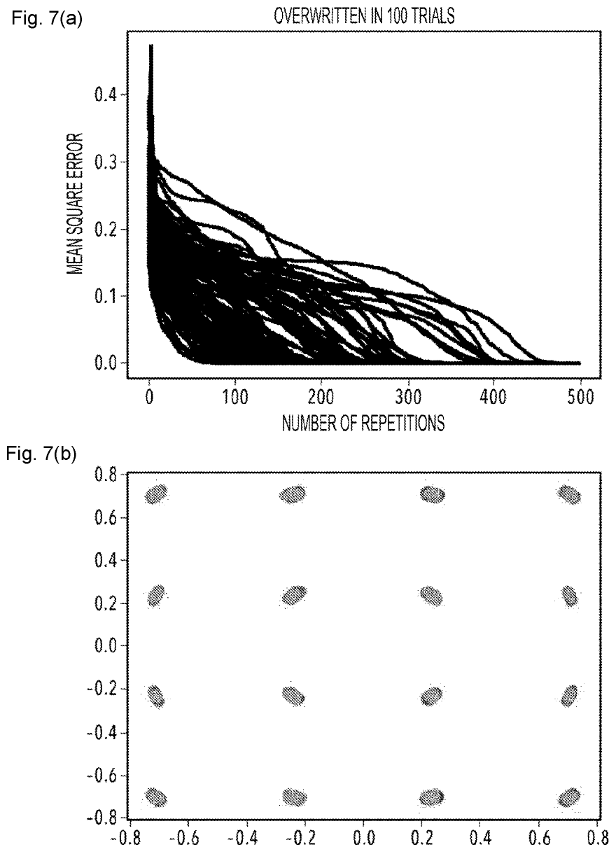

FIG. 7(a) shows the results of estimation in a case where the Wirtinger flow was used for the demodulation algorithm. The abscissa axis indicates the number of repetitions in one trial, and the ordinate axis indicates the mean square error between the demodulated complex time-series signal u^{est} that was overwritten in 100 trials and the complex time-series signal u of the original signal. The impulse response of the lattice filter in this case was measured in advance, and h and h* were known values. λ(n) was set according to the following expression that was empirically obtained.

$$\begin{matrix}[ Math . 7 ] & \\ λ ( n ) = a \times min [ \{ 1 - exp ( \frac{n}{T} ) \} , 0.5 ] & ( 7 )\end{matrix}$$

Here, a=0.5 T=100. Further, a and T are hyperparameters.

FIG. 7(a) illustrates the error between the demodulated complex time-series signal u^{est} and the complex time-series signal u of the original signal at each time of a repetition. FIG. 7(b) illustrates a constellation of the demodulated complex time-series signal u^{est} repeatedly estimated 500 times. Here, λ(n) was formed with a plurality of combinations of a and T. In any λ(n), the mean square error is small when the number of repetitions is 500, and the demodulated complex time-series signal u^{est} can be obtained with a higher likelihood. As can be seen from FIG. 7, by applying this embodiment, it is possible to demodulate an optical signal in a complex space from an intensity signal.

Next, a case where estimation was performed with the demodulation algorithm 235 that performed the neural network calculation described above with reference to FIG. 5 is explained. The number of layers in the network was set to 300, and the parameters H and λ of each layer were common to all layers so as to reduce the calculation load. In the case of this mode, prior knowledge about h and λ is unnecessary, and, as described above with reference to FIG. 5, h and λ are first learned by training, and subsequently, the demodulated complex time-series signal u^{est} is calculated with the use of the optimized h.

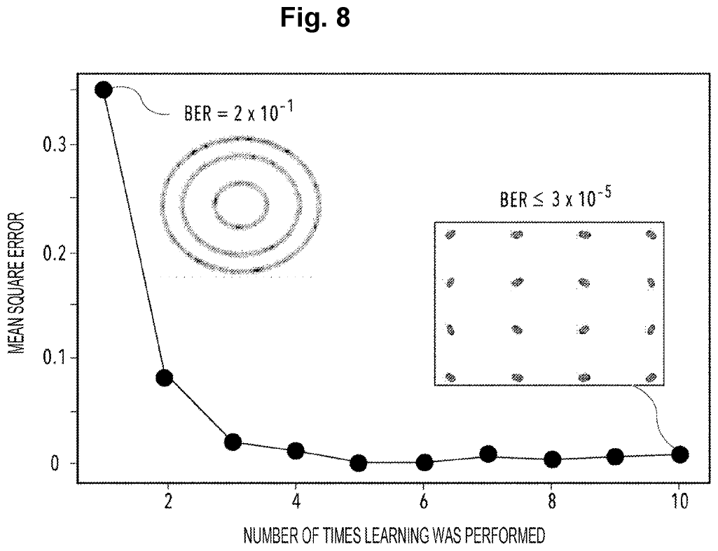

FIG. 8 is a graph showing the square error between the complex time-series signal u and the predicted demodulated complex time-series signal u^{est} in a case where learning was performed with the same calculation parameters as those described above, using the demodulation algorithm 235 illustrated in FIG. 5. FIG. 8 also illustrates the constellation before the learning and the constellation after the learning. As can be seen from FIG. 8, the error decreases as the learning progresses, and signals can be restored without any prior knowledge in this configuration.

### INDUSTRIAL APPLICABILITY

It is possible to provide a coherent optical receiver that reproduces an optical complex signal that was used when an optical signal was generated in a coherent optical transmitter, without any use of local carrier light.

### REFERENCE SIGNS LIST

101 Coherent optical transmitter
102 Optical MUX circuit
103 Optical transmission line
104 Optical DEMUX circuit
105 Coherent optical receiver
106 Digital signal processing device
107 Optical signal
108 Laser light source
109 Optical coherence system
210 Coherent optical transmitter
211 I/Q modulator
220 Optical transmission line
230 Coherent optical receiver
233 Optical convolution circuit
234 Photodetector
235 Demodulation algorithm
301 Branching unit
302 Optical delay line
303 Phase shifter
304 Variable attenuator
305 Merging unit
301a Optical splitter
301b Variable optical splitter
305a Optical coupler
305b Variable optical coupler
500 Optical convolution circuit
501 N×J optical cross-connect
502 J×K optical cross-connect

1. A coherent optical receiver that reproduces a complex time-series signal from an optical signal received via an optical transmission line, the complex time-series signal having been used to generate the optical signal,
the coherent optical receiver comprising:
an optical convolution circuit that performs optical signal processing on the received optical signal;
a photodetector that converts the optical signal subjected to the optical signal processing into an electrical signal having an intensity waveform of the optical signal subjected to the optical signal processing; and
a demodulation algorithm that estimates the complex time-series signal by performing digital signal processing on the electrical signal, and sets the estimated complex time-series signal as a result of reproduction of the complex time-series signal used in generating the optical signal.

2. The coherent optical receiver according to claim 1, wherein
the optical convolution circuit includes:
a branching unit that branches the received optical signal;
an optical delay line that gives different delay differences between the branched optical signals;
a phase shifter that is disposed on the optical delay line, and gives a phase to the branched optical signal; and
a merging unit connected to the optical delay line.

3. The coherent optical receiver according to claim 2, wherein
the optical convolution circuit includes:
an attenuator that is disposed on the optical delay line, and gives attenuation to the branched optical signal.

4. The coherent optical receiver according to claim 2, wherein the branching unit is a variable optical splitter.

5. The coherent optical receiver according to claim 1, wherein
the optical convolution circuit includes:
an N×J optical cross-connect that has N input ports and J output ports, and connects the N respective input ports to the J respective output ports, the received optical signal input from an input port of the N input ports being distributed to the J output ports; and
a J×K optical cross-connect that has J input ports and K output ports, and connects the J respective input ports to the K respective output ports;
J optical delay lines that connect the J output ports of the N×J optical cross-connect to the J input ports of the J×K optical cross-connect, and gives a delay difference between optical signals distributed to the J output ports of the N×J optical cross-connect;
a phase shifter that is disposed on the optical delay line, and gives a phase to the distributed optical signal; and
an attenuator that is disposed on the optical delay line, and gives attenuation to the distributed optical signal.

6. The coherent optical receiver according to claim 1, wherein the demodulation algorithm estimates the complex time-series signal by calculating a learning model, with inputs being the electrical signal and an impulse response in the optical convolution circuit.

7. The coherent optical receiver according to claim 6, wherein the demodulation algorithm learns the impulse response by calculating the learning model.
